(19) United States
(12) Patent Application Publication
(10) Pub. No.: US 2003/0046364 A1
(43) Pub. Date: Mar. 6, 2003

(54) Web interface

(76) Inventors: Lonnie Sisco, Portage, MI (US); Randy Clark, Kalamazoo, MI (US); Allen Smith, Marcellus, MI (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 09/904,503

(22) Filed: Jul. 16, 2001

Related U.S. Application Data
(60) Provisional application No. 60/297,242, filed on Jun. 12, 2001.

(51) Int. Cl. G06F 15/16

(52) U.S. Cl. 709/219; 709/228

(57) ABSTRACT

A system and method for interfacing between Baan software applications and the Internet. The system includes a web page for inputting data into a graphical user interface, an Active X DLL program for compiling the data, a Baan application function server for receiving the data from the Active X DLL program, and Baan software objects for receiving the data from the Baan application function server.

### PRIORITY

This application claims priority to the provisional application entitled Web Interface, serial No. 60/297,242, filed Jun. 12, 2001.

### COPYRIGHT PROTECTION

This disclosure contains material which is subject to copyright protection. The copyright owner has no objection to the reproduction by anyone of the patent document or the patent disclosure as it appears in the Patent and Trademark Office patent file or records, but otherwise reserves all copyright rights. The following notice applies to the software and data as described below and in the drawings hereto: Copyright 2001 SPX Corporation, All rights reserved.

### FIELD OF THE INVENTION

The present invention relates generally to a system and method for interfacing between computer software and the Internet. More particularly, the present invention relates to providing a system and method for interfacing between Baan software applications and the Internet.

### BACKGROUND OF THE INVENTION

Typically, members of an organization have access to an individual computer that is connected to a network. A network is defined as a connection between two or more computers for the sharing of resources. Often, members of an organization seek access to the resources of the network when they are not accessible to a computer that is a member of the network.

For example, businesses that sell equipment often enter agreements with their customers to service the equipment if there are any problems. In an event that the equipment malfunctions, an employee or independent contractor related to the business that services the equipment, typically referred to as a field service technician, receives instructions to go to the customers location to service the equipment. The field service technician may be at a location that does not have direct access to the network of the original equipment manufacturer.

For business purposes, the selling company wants to maintain records of data relating to the service requests. For example, the selling company wants information relating to the resources allocated to the service call, such as the technician who performed the service, the time the technician spent working on the equipment, the parts that were used in repairing the machines, etc.

An original equipment manufacturer maintains databases of information related to the service of the equipment to access when planning for the needs of the business. Additionally, the original equipment manufacturer is able to track problems associated with a particular piece or type of equipment. By analyzing the data related to the products, the original equipment manufacturer is able to develop various business solutions, such as those related to the product and/or the finances of the business. Thus, the original equipment manufacturer is able to advance product sales.

In some instances, the field service technician gives this information to a third party, such as a customer service technician located at the site of the original equipment manufacturer, who will include the service data with other data related to the company's resources. The field service technician gives the information to the customer service technician because the software, which maintains the data, is not stored on the computer the technician uses in the field. The software is stored on the customer service technician's computer. It would be too costly to store the software on each field service technician's computer. However, use of a customer service technician to enter data into the company's system for administration of the business, has the potential of affecting the integrity of the information, if it is not entered correctly.

Accordingly, it is desirable to provide a system and method for allowing users access to a Baan, when Baan is not available on the user's computer. Baan is business enterprise software, which processes and or allocates the storing of data input into a network, and sorts the input data according to different aspects of the business, such as manufacturing, distribution, and finance. This would provide the user with the ability to directly enter information in Baan, and thus, would eliminate the need for a third party. Accordingly, costs would be reduced. In addition, the integrity of the information would be improved because the user is able to directly enter the information. Because the data maintained can be used for up-to-date business planning, it is important that the information be timely and accurate. In addition, it is desirable to provide a low cost method for users to input information into Baan software applications.

### SUMMARY OF THE INVENTION

In one aspect of the invention, a method for accessing a Baan server is provided that includes the steps of sending data from a Visual Basic program to a Baan server, receiving the data at the Baan server, and storing information in the Baan server in response to the received data.

In another aspect of the invention, a system for accessing a Baan server is provided that includes a network server containing a Visual Basic program, and a Baan server, wherein the Visual Basic program is used to access the Baan server.

In another aspect of the invention, a system for accessing Baan is provided that includes a computer means for accessing a network server, a network server means for accessing a Baan server through a Visual Basic program, and a Baan software means for managing and processing data as directed by the computer means.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates an interface system in accordance with the present invention.

FIG. 2 is a screen shot of an exemplary embodiment of a data input screen in accordance with the present invention.

FIG. 3 is a screen shot of an exemplary embodiment of a data input screen in accordance with the present invention.

FIG. 4 is a flow chart of a method of interfacing with Baan in accordance with the present invention.

### DETAILED DESCRIPTION OF THE PREFERRED EMBODIMENTS

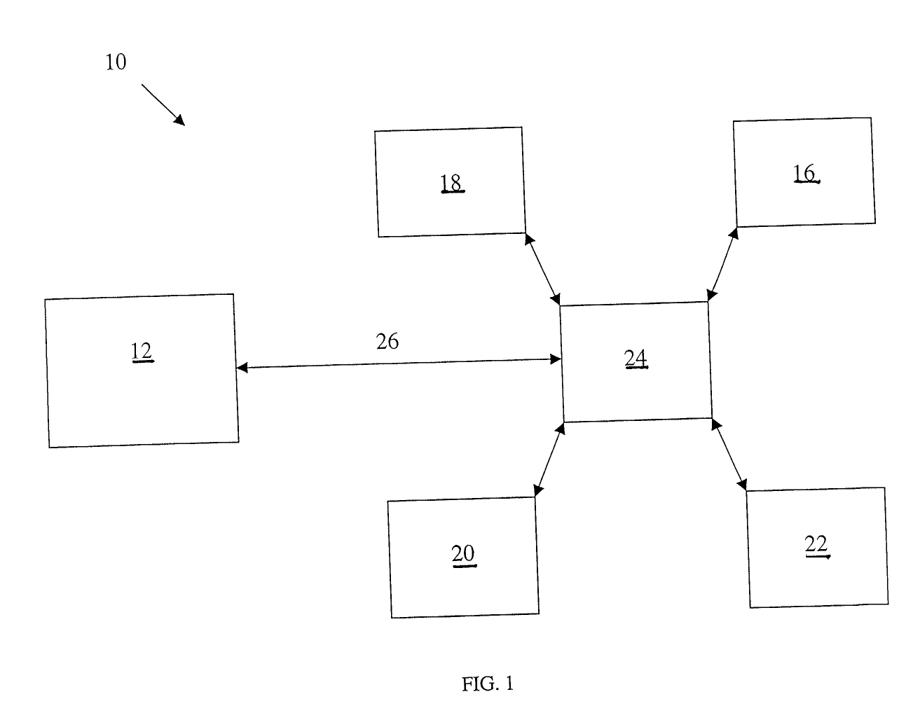

An exemplary embodiment of the present invention provides a system and method for interfacing to software applications on a server remotely over the Internet. Referring now to the figures, wherein like reference numerals indicate like elements, in FIG. 1 there is shown an embodiment of an exemplary system, according to the present invention. As shown in FIG. 1, the system 10 includes a computer 12 that is used for communicating information between a user and a network of computers 16-22. In a preferred embodiment the computer 12 is a personal computer (PC) or a laptop computer. As depicted, the network 16-22 includes computer devices 16-22 all linked to a central server 24. Software that manages and/or processes data is provided to the network 16-22. In an exemplary embodiment of the present invention, the software provided to the network is Baan software.

The graphical user interface of the computer 12 facilitates interaction with the Baan software. A graphical user interface may include, for example, a cursor, drop-down menus for operation by a pointing device, multi-tasking capabilities, a screen divided into separate windows, graphical images that let a user know what the CPU is doing, graphical images that allow a user to provide instructions to a CPU, and/or icons to represent different applications, tasks, files and commands. According to a preferred embodiment of the invention, the graphical user interface is able to communicate with the Baan software directly over the Internet 26. By using the Internet 26, a user is able to transmit data to the Baan software and is able to receive data from the Baan software without having Baan installed on the user's computer 12.

By accessing the network 14, a user is able to use the Internet 26 for communication between the computer 12 and the Baan software. For access to Baan, a user may be required to enter a user ID and/or password. It is anticipated that a company providing data services using Baan software may provide access into the network 14 through an appropriate web page.

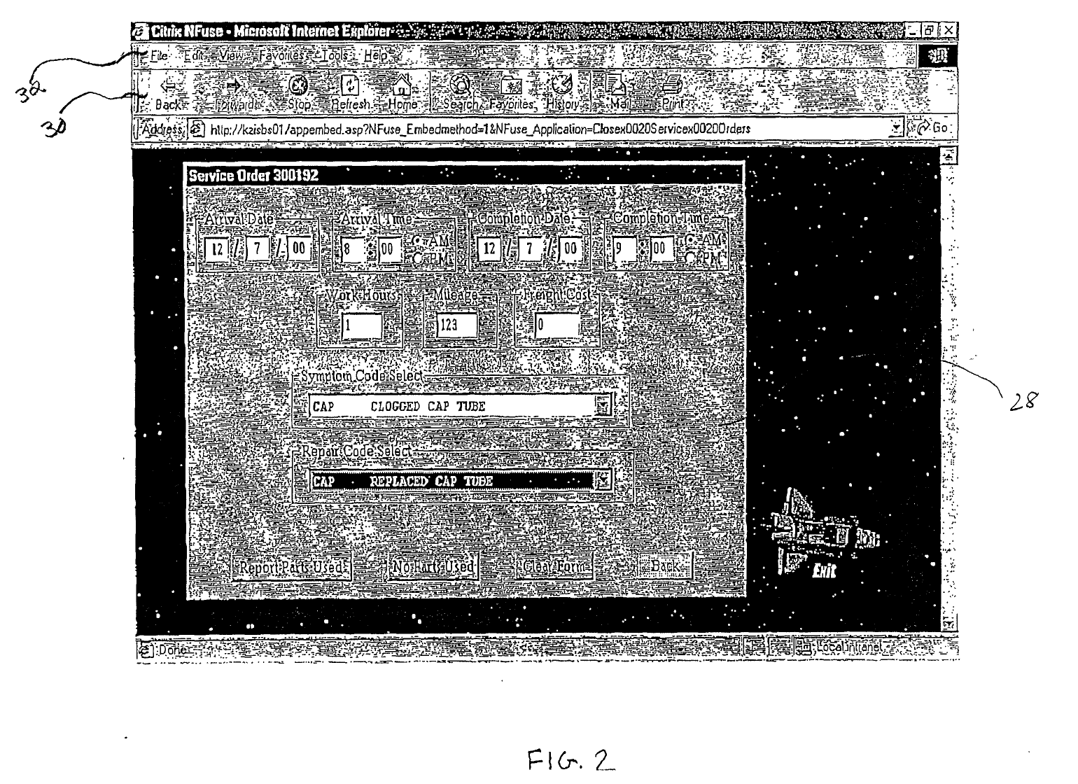

A user inputs data into Baan through Baan sessions. Baan sessions consist of inquiries, which may be customized to a particular business, that appear in a template format on the graphical user interface of the computer 12. Shown in FIG. 2, is a screen shot of an exemplary embodiment of a data input screen 28 of a Baan session. The data input screen 28 for the Baan session is accessed using the Internet and displayed using a web browser, e.g., Microsoft Internet Explorer. Alternatively, there are remote access programs, which allow information residing on the network 14 to be remotely accessed. One such remote access program is CITRIX. As shown in FIG. 2, the data input screen is running on CITRIX, and displayed using Microsoft Internet Explorer. The data input screen 28 shown in FIG. 2 is a service order screen for entering information relative to a request for automotive service. As shown, the service order screen has fields for entering data relative to service of an automobile, such as:

1) the date and time the technician arrived;

2) the date and time the technician completed the service;

3) the number of hours the technician spent performing the service;

4) the parts used;

5) the parts repaired, etc.

Further, as shown in FIG. 2, the technician is able to utilize the Microsoft Internet Explorer Toolbars 30 and 32 for navigating through Baan sessions and completing the data input screens.

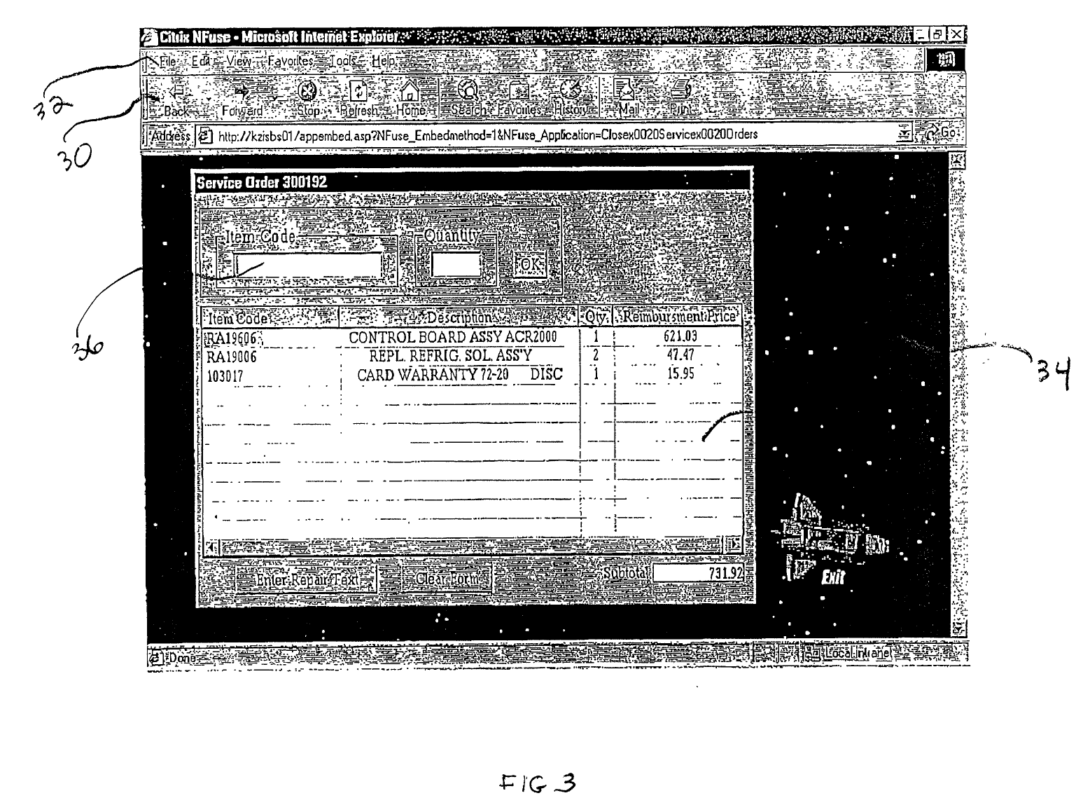

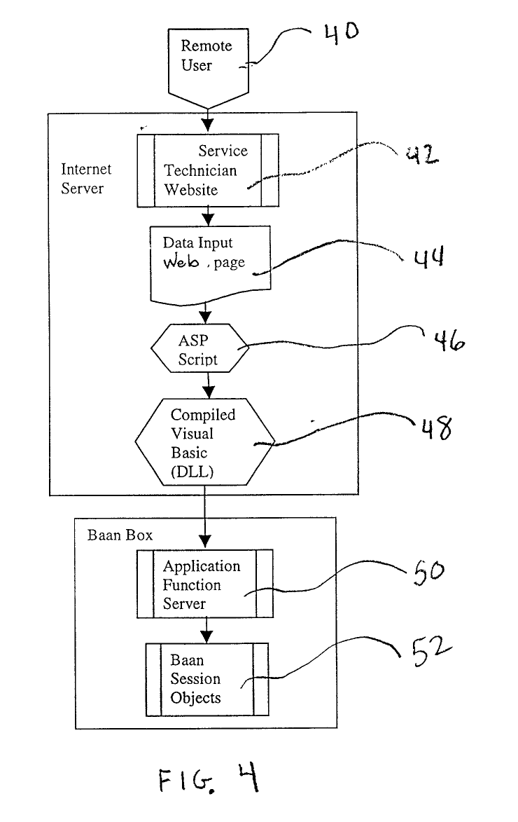

As shown in FIG. 3, the data input screen 34 is a screen for ordering parts. As shown in FIG. 4, the service technician is able to enter the number associated with a part in the item code field 36 and the Baan session will display/submit information relative to the part entered in a spreadsheet format. In addition, the technician is able to utilize the Microsoft Internet Explorer Toolbars 30 and 32 for navigating through Baan sessions and completing the data input screens. Each Baan session is associated with a Baan software object that allocates the input data to respective databases, such as manufacturing, distribution and finance.

Typically, a user must have direct access to Baan, such as having Baan installed on the user's computer, in order for the user to enter information directly into Baan. However, by using the Internet, and the system and/or method of interfacing with Baan, according to the present invention, a user is able to utilize Baan without having Baan installed on the user's computer.

FIG. 4 is a flow chart describing the steps of an exemplary embodiment of a method for interfacing with Baan, according to the present invention. To access the Baan software, a user logs onto a server remotely 40 using a remote login program, such as CITRIX. The service technician then accesses the Baan software through a web page provided to the server 42. The web page is used by the user for the entry of data 44 into the web page that is representative of a Baan session. The web page may be developed using HyperText Markup Language (HTML) and placed on a web server. HyperText Markup Language is the coding language used to create hypertext documents for use on the World Wide Web. HTML is a “markup language” that adds tags to your text which tell a browser, such as Netscape or Internet Explorer, how to display it. The web page may also be developed using Microsoft's Active Server Pages (ASP) or ASP in combination with the HTML. In a preferred embodiment, in accordance with the present invention, Microsoft Active Server Pages are utilized. A web page may contain both HTML and ASP scripting code. In step 46, the ASP script passes the data to a compiled Visual Basic program. The compiled Visual Basic program initiates sending data to Baan 48. Thus, in accordance with the present invention, ASP web pages can be utilized to input data into Baan. In addition, programs developed using an Active X DLL such as Visual Basic, can be utilized to validate all data prior to sending the data to Baan. Provided below is exemplary code snippets of a compiled Visual Basic program, in accordance with the present invention:

Sub SetToCompleted( )
Set BaanObj = CreateObject (“Baan4.Application”)

(creates a Baan OLE object)

BaanObj.ParseExecFunction “ottstpapihand”, stpapi handle.subproc(“& Chr(34) & “tssma3142m000” & Chr(34) & “,” & Chr(34) & “tssma3110s000” &

Chr(34) & “,” & Chr(34) & “kill” & Chr(34) & “)”

(Starts Baan session tssma3142m000 Report Calls Completed and prevents the subsession tssma3110m000 from starting)

BaanObj.ParseExecFunction“ottstpapihand”, “stpapi.change view(“ & Chr(34) & “tssma3142m000” & Chr(34) & ”)”

(Sets the focus to the session tssma3142m000)

BaanObj.ParseExecFunction “ottstpapihand”, “stpapi.put.field(” & Chr(34) & “tssma3142m000” & Chr(34) & “,” & Chr(34) & “tssma301 orno” &

Chr(34) & “,” & Chr(34) & CallInfo(0) & Chr(34) & “)”

(Puts the order number entered by the user into the order number field of the session)

BaanObj.ParseExecFunction “ottstpapihand”, “stpapi.continue.process(” & Chr(34) & “tssma3142m000” & Chr(34) & “,” & Chr(34) & Space(50) &

Chr(34) & “)”

(Processes an [Enter] command for the session)

BaanObj.ParseExecFunction “ottstpapihand”, “stpapi.find(” & Chr(34) & “tssma3142m000” & Chr(34) & “)”

(Finds the records for the session relating to the order number)
(The next 8 lines places data into the session's fields)

BaanObj.ParseExecFunction “ottstpapihand”, “stpapi, put field(” & Chr(34) & tssma3142m000” & Chr(34) & “,” & Chr(34) & “tssma301.cprl”

& Chr(34) & “,” & “Chr(34) & “1” & Chr(34) & “)”

BaanObj.ParseExecFunction “ottstpapihand”, “stpapi.put.field(” & Chr(34) & tssma3142m000” & Chr(34) & “,” & Chr(34) & “tssma301.cfix” &

Chr(34) & “,” & Chr(34) & FixCode & Chr(34) & “)”

BaanObj.ParseExecFunction “ottstpapihand”, “stpapi.put.field(” & Chr(34) & tssma3142m000” & Chr(34) & “,” & Chr(34) & “tssma301.ddt6” &

Chr(34) & “,” & Chr(34) & ArrivalDate & Chr(34) & “)”

BaanObj.ParseExecFunction “ottstpapihand”, “stpapi.put.field(” & Chr(34) & tssma3142m000” & Chr(34) & “,” & Chr(34) & “tssma301.dtm6” &

Chr(34) & “,” & Chr(34) & ArrivalTime & Chr(34) & “)”

BaanObj.ParseExecFunction “ottstpapihand”, “stpapi.put.field(” & Chr(34) & tssma3142m000” & Chr(34) & “,” & Chr(34) & “tssma301.ddt7”

& Chr(34) & “,” & Chr(34) & CompleteDate & Chr(34) & “)”

BaanObj.ParseExecFunction “ottstpapihand”, “stpapi.put.field(” & Chr(34) & tssma3142m000” & Chr(34) & “,” & Chr(34) & “tssma301.dtm7” &

Chr(34) & “,” & Chr(34) & CompleteTime & Chr(34) & “)”

BaanObj.ParseExecFunction “ottstpapihand”, “stpapi.put.field(” & Chr(34) & tssma3142m000” & Chr(34) & “,” & Chr(34) & “tssma301.emno”

& Chr(34) & “,” & Chr(34) & CallInfo & Chr(34) & “)”

BaanObj.ParseExecFunction “ottstpapihand”, “stpapi.put.field(” & Chr(34) & tssma3142m000” & Chr(34) & “,” & Chr(34) & “tssma301.swor” &

Chr(34) & “,” & Chr(34) & “4” & Chr(34) & “)”

(Puts the data in the session's fields that was entered by the user)

BaanObj.ParseExecFunction “ottstpapihand”, “stpapi update(” & Chr(34) & tssma3142m000” & Chr(34) & “,” & 1 & “,” Chr(34) & Space(50) &

Chr(34) & “)”

(Updates the database records for the specified order number)

BaanObj.ParseExecFunction “ottstpapihand”, “stpapi.continue.process(” & Chr(34) & tssma3142m000” & Chr(34) & “,” & Chr(34) & Space(50) &

Chr(34) & “)”

(Processes an [Enter] command for the session)
If Len(BaanObj FunctionCall)>43 Then

(If an error occurred)

ErrorMsg=BaanObj.FunctionCall
BaanObj.ParseExecFunction “ottstpapihand”, “stpapi.recover(” & Chr(34) & tssma3142m000” & Chr(34) & “,” & Chr(34) & Space(50) &

Chr(34) & “)”

(Undo all changes)

BaanObj.ParseExecFunction “ottstpapihand”, “stpapi end session(” & Chr(34) & tssma3142m000” & Chr(34) & “)”

(End the session tssma3142m000)

BaanObj Quit
Set BaanObj=Nothing

(Close the Baan OLE object)

MsgBox (“There is an unknown problem with ServiceOrder# ” & CallInfo(0) & vbCrLf & “The information will be sent to Kalamazoo for
manual closure.”)

(Inform user of an error)

ToKzooNotBaan
Else
PostParts
End If

End Sub

Specifically, the compiled Visual Basic program sends the data to the Application Function Server (AFS) of Baan. The AFS is responsible for communicating the data entered to the software objects that contain the underlying logic for the sessions. The software objects allocate the data to the appropriate databases. The software objects of Baan are referred to as Baan Session Objects. The Baan Session Objects are programs of a higher level language than Visual Basic. The AFS serves as an interface that allows the Visual Basic programs to communicate with the Baan Session Objects 50. The AFS contains functions for setting and retrieving values for fields in the underlying Baan Session Objects. It may also contain functions to add, edit, or delete records from a Baan Session Objects. Additionally, the AFS is capable of performing other functions such as setting answers to questions, handling subsessions, and retrieving error messages. The AFS may serve as an Application Program Interface, which may be provided by a Business Object Interface (BOI). In step 52 the Baan Session Objects manage process and/or allocate the storing of the data entered by the service technician.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for accessing a Baan server, comprising the steps of: sending data from a Visual Basic program to a Baan server;
receiving the data at the Baan server; and
storing information in the Baan server in response to the received data.

2. The method of claim 1, wherein the Visual Basic program is an Active X DLL program.

3. The method of claim 1, further comprising the steps of:
accessing the Visual Basic program, which is resident on a server, from a computer over a network link.

4. The method of claim 3, wherein said network link is an Internet.

5. The method of claim 3, wherein said accessing step is accomplished through a web page developed using Active Server Pages (ASP) script.

6. The method of claim 5, wherein said Baan server provides data services for automotive service applications.

7. The method of claim 6, wherein said network link is an Internet.

8. The method of claim 7, wherein the Visual Basic program is an Active X DLL program.

9. The method of claim 7, wherein said accessing step is accomplished using a remote network access program.

10. The method of claim 9, wherein the remote access program is CITRIX.

11. A system for accessing a Baan server, comprising:
a network server containing a Visual Basic program; and
a Baan server, wherein the Visual Basic program is used to access the Baan server.

12. The system of claim 11, wherein said network server is an Internet server.

13. The system of claim 11, wherein said network server, further contains a web page developed using ASP script, and wherein said web page is used to provide information to said Visual Basic program for accessing said Baan server.

14. The system of claim 11, further comprising:
a computer for accessing said network server.

15. The system of claim 14, wherein said user accesses said network server using a remote network program.

16. The system of claim 15, wherein the remote network program is CITRIX.

17. A system for accessing Baan, comprising:
a computer means for accessing a network server;
a network server means for accessing a Baan server through a Visual Basic program; and
a Baan software means for managing and processing data as directed by the computer means.

18. The system of claim 17, wherein the computer means utilizes an Internet to access the network server.

19. The system of claim 17, wherein the data is automotive data.

20. The system of claim 17, wherein the data is at least one of financial, manufacturing, and distribution data.
